(19) United States
(12) Patent Application Publication
(10) Pub. No.: US 2004/0011599 A1
(43) Pub. Date: Jan. 22, 2004

(54) Disc brake device for cycles having adjustable lever

(76) Inventor: Lynn Allan Miles, Taichung (TW)

Correspondence Address: CHARLES E. BAXLEY, 5th Floor, 59 John Street, New York, NY, 10038, US

(21) Appl. No.: 10/199,603

(22) Filed: Jul. 22, 2002

(51) Int. Cl. B62L 3/00

(52) U.S. Cl. 188/24.22

(57) ABSTRACT

A disc brake device for cycles includes a housing having two brake shoes disposed beside a brake disc, an actuating member for operating the brake shoes, and a cam secured to the actuating member. The cam includes an outwardly extended cam, and a brake cable has an inner wire adjustably secured to the lever at different locations or distances relative to the cam, for allowing the inner wire to actuate onto the cam with different torques with the lever. The lever has a number of recessed for adjustably receiving the inner wire which may be secured to the lever with a fastener.

### BACKGROUND OF THE INVENTION

1. Field of the Invention

The present invention relates to a disc brake device, and more particularly to a disc brake device for cycles having an adjustable actuating lever.

2. Description of the Prior Art

Various kinds of typical disc brake devices have been developed for cycles or the like, and comprise a brake cable coupled to an actuating lever for actuating a cam actuating device to actuate or to force a pair of brake shoes to engage with a brake disc, in order to brake the cycles. U.S. Pat. No. 3,765,511 to Toyomasu discloses one of the typical disc brake devices.

For different kinds of cycles, such as the mountain bikes, the city bikes, the trekking bikes, the racing bikes, different forces or torques are required to be applied to the cam actuating device in order to suitably actuate the cam actuating device to brake the brake disc with the brake shoes.

However, the typical disc brake devices includes a brake cable solidly secured to the actuating lever and may not be adjusted relative to the actuating lever, such that the brake cable may not force the actuating lever to apply different torques or forces against the brake shoes or the brake disc, such that a number of different kinds of typical disc brake devices are required to be provided and attached onto different bikes or cycles.

The present invention has arisen to mitigate and/or obviate the afore-described disadvantages of the conventional disc brake devices for cycles.

### SUMMARY OF THE INVENTION

The primary objective of the present invention is to provide a disc brake device for cycles including an adjustable actuating lever for adjusting to different torques and suitable for attaching onto various kinds of bikes or cycles.

In accordance with one aspect of the invention, there is provided a disc brake device for cycles comprising a brake disc, a housing including a pair of brake shoes provided therein and disposed beside the brake disc, an actuating member disposed in the housing for operating the brake shoes to act onto the brake disc, the actuating member including an extension extended therefrom, a cam secured to the extension of the actuating member, and including a lever extended therefrom, a brake cable including an inner wire, and means for adjustably securing the inner wire to the lever at different locations or distances relative to the cam, and for allowing the inner wire to actuate onto the cam with different forces or torques with the lever.

The adjustably securing means includes a fastener for securing the inner wire to the lever at different locations, for allowing the inner wire to apply different torque against the cam with the lever.

The lever includes a plurality of recessed formed therein for selectively and adjustably receiving the inner wire.

The adjustably securing means further includes a washer engaged onto the fastener and engaged with the inner wire for securing the inner wire to the lever.

The washer includes a cavity formed therein for receiving the inner wire and for solidly securing the inner wire to the lever.

The lever includes a channel formed therein for slidably receiving the fastener, and a lock nut threaded with the fastener for securing the fastener and the inner wire to the lever.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial exploded view of a disc brake device for cycles in accordance with the present invention;

FIG. 2 is a partial cross sectional view of the disc brake device;

FIG. 3 is a partial cross sectional view taken along lines 3-3 of FIG. 1;

FIG. 4 is a partial exploded view similar to FIG. 1, illustrating another embodiment of the disc brake device; and

FIG. 5 is a partial exploded view similar to FIGS. 1 and 4, illustrating a further embodiment of the disc brake device.

### DETAILED DESCRIPTION OF THE PREFERRED EMBODIMENT

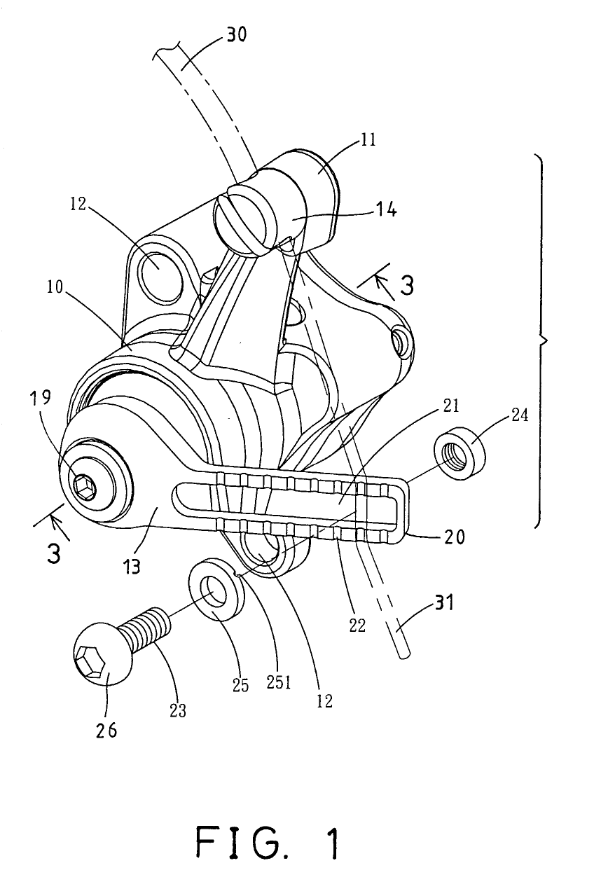

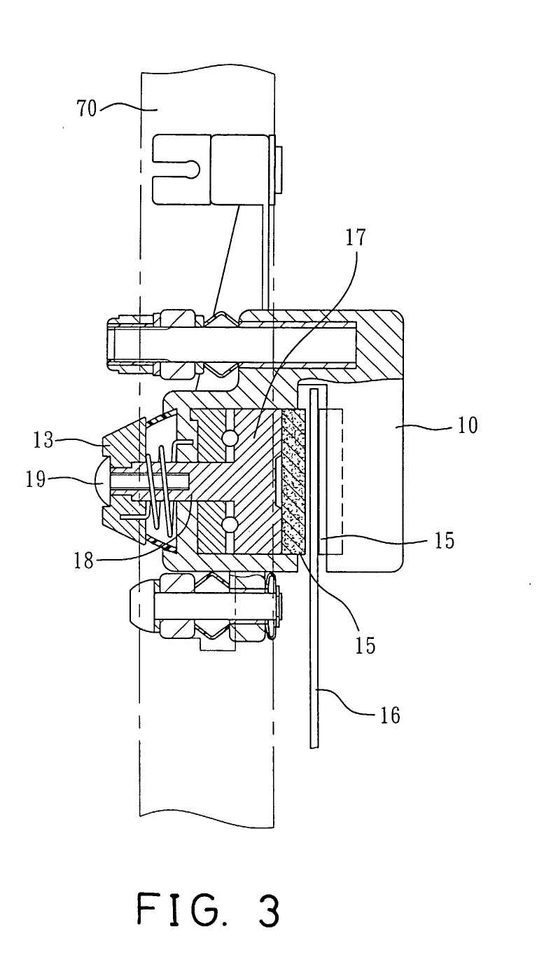

Referring to the drawings, and initially to FIGS. 1-3, a disc brake device for cycles in accordance with the present invention comprises a housing 10 including one or more holes 12 formed or provided therein for attaching or securing onto the cycles 70, such as the forks of the cycles 70 (FIG. 3).

As shown in FIG. 1, the housing 10 includes a seat 11 extended therefrom, and a fastener 14 attached to the seat 11 for adjustably securing the brake cable 30 to the seat 11. The brake cable 30 includes an inner wire 31 slidable and extendible out through the fastener 14.

As shown in FIG. 3, the housing 10 includes one or more, such as two brake shoes 15 slidably disposed therein, and disposed beside the peripheral portion of a brake disc 16, for engaging with or for acting onto the brake disc 16 in order to conduct the typical braking operations.

An actuating member 17 is disposed in the housing 10 for engaging with or for acting onto the brake shoes 15 to act onto the brake disc 16. The actuating member 17 includes a shaft 18 extended outwardly of the housing 10, and secured to a cam 13 with one or more fasteners 19.

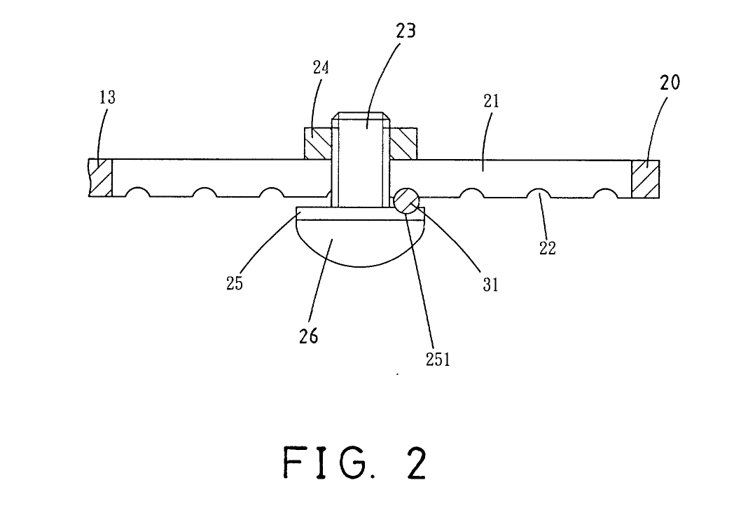

As shown in FIGS. 1 and 2, the inner wire 31 of the brake cable 30 will then be secured to a lever 20 extended from the cam 13, in order to force or to rotate the cam 13 and then to cause the actuating member 17 to force the brake shoes 15 to act onto the brake disc 16.

The lever 20 of the cam 13 includes a longitudinal channel 21 formed therein, and includes one or more recesses 22 formed along the length thereof and communicating with the channel 21 thereof, for selectively or adjustably receiving the inner wire 31 of the brake cable 30.

A fastener 23 is engaged through the channel 21 of the lever 20, and includes a head 26 for engaging with the lever 20 directly, or indirectly with a washer 25. For example, the washer 25 may include one or more cavities 251 formed in one side thereof for partially receiving the inner wire 31 of the brake cable 30. A lock nut 24 may be threaded to the fastener 23 for securing the inner wire 31 to the lever 20.

As best shown in FIG. 2, the inner wire 31 may be suitably received in either of the recesses 22 of the lever 20, and in the cavity 251 of the washer 25, such that the inner wire 31 may be solidly secured to the lever 20 with the fastener 23. The fastener 23 thus forms a fastening means for adjustably securing the inner wire 31 to the lever 20.

In operation, as shown in FIGS. 1 and 2, the inner wire 31 may be selectively engaged in either of the recesses 22 of the lever 20, such that the inner wire 31 may be secured to the lever 20 at different locations or positions relative to the cam 13 or the fastener 19 or the shaft 18.

For example, when the inner wire 31 is secured to the lever 20 at a farther location or position relative to the cam 13 or the fastener 19 or the shaft 18, or when the inner wire 31 is located farther away from the cam 13 or the fastener 19, the users may pull or force the inner wire 31 to apply a greater torque to the cam 13 and to then act onto the brake disc 16. The brake device may be used for racing bikes, for example.

On the contrary, when the inner wire 31 is secured to the lever 20 and located closer to the cam 13 or the fastener 19, the users may pull or force the inner wire 31 to apply a relatively smaller torque to the cam 13 and to then act onto the brake disc 16. The brake device may thus be used for city bikes, for example.

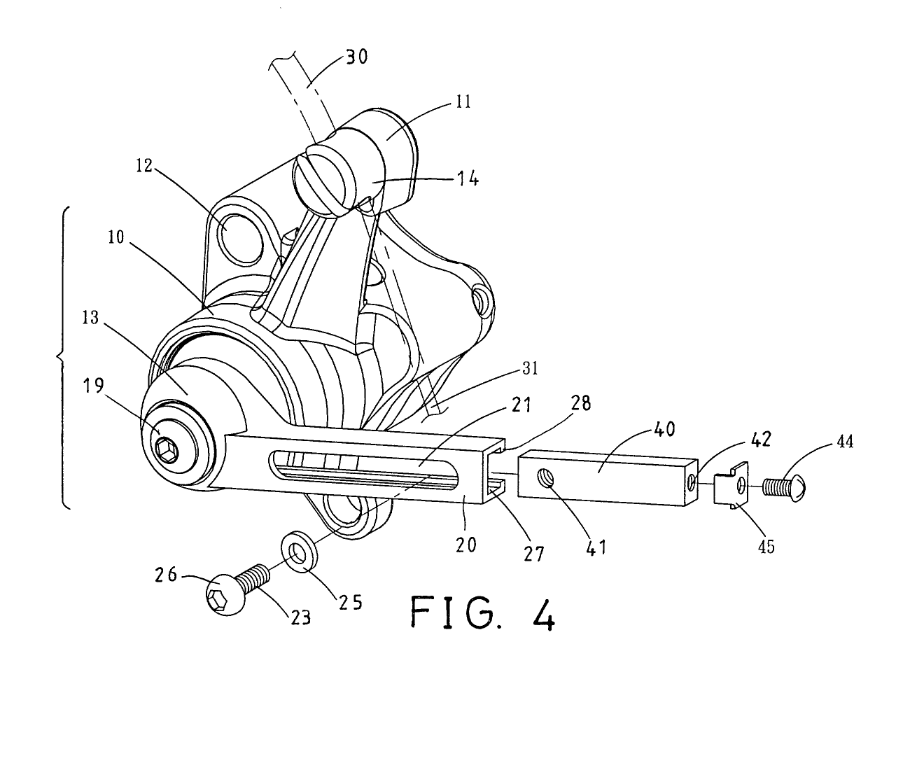

Referring next to FIG. 4, illustrated is another embodiment of the disc brake device. The lever 20 includes a passage 27 formed therein and defined by a pair of longitudinal flanges 28, and communicating with the channel 21 thereof for slidably receiving a bar 40 therein.

For example, the bar 40 includes a screw hole 41 formed therein for receiving the fastener 23 and for adjustably securing the bar 40 to the lever 20, and includes another screw hole 42 formed in the outer end thereof for threading with another fastener 44 which may secure the inner wire 31 of the cable 30 to the bar 40 with a bracket 45.

In operation, the bar 40 may be adjusted relative to the lever 20, in order to adjust the location or the distance of the inner wire 31 relative to the cam 13, and so as to adjust the force or the torque of the inner wire 31 that may be applied to the cam 13.

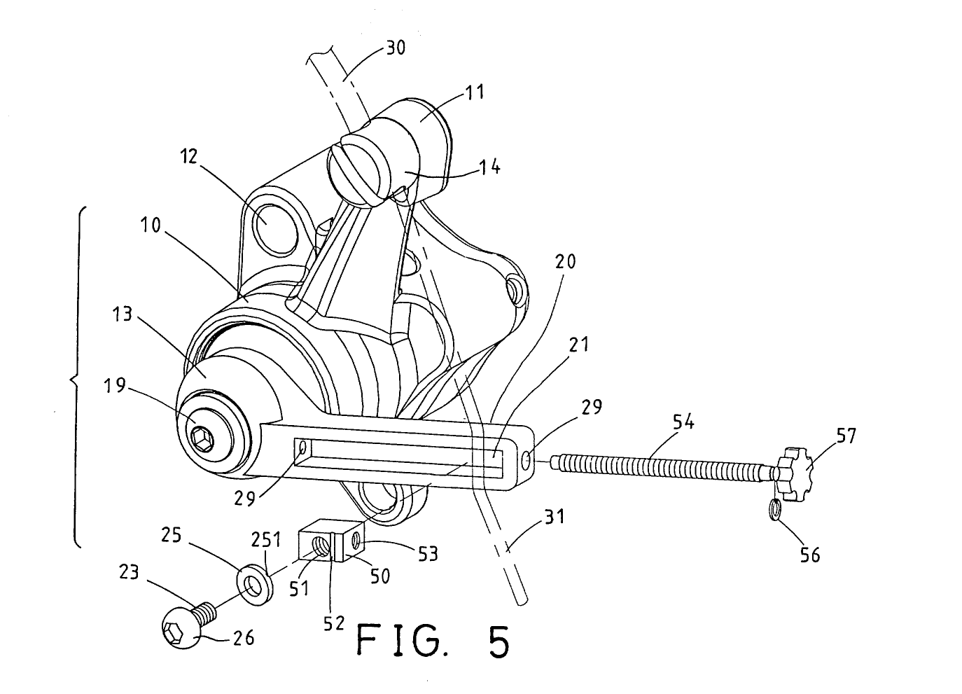

Referring next to FIG. 5, illustrated is a further embodiment of the disc brake device. The lever 20 includes a through hole 29 laterally formed therein and communicating with the channel 21 thereof for rotatably receiving a bolt 54 in the channel 21 of the lever 20.

The bolt 54 may be rotatably secured to the lever 20 with a retaining ring 56, and has a knob 57 for rotating the bolt 54 relative to the lever 20. A follower 50 is slidably received in the channel 21 of the lever 20 and includes an inner thread 53 formed therein for threading with the bolt 54. The bolt 54 may move the follower 50 along the channel 21 of the lever 20 by rotating the bolt 54 relative to the lever 20.

The follower 50 includes a screw hole 51 and a recess 52 formed in the other side thereof. The inner wire 31 may also be received in the recess 52 of the follower 50 and the cavity 251 of the washer 25, and may be secured to the follower 50 with the fastener 23. The inner wire 31 may thus be adjusted relative to the lever 20 by the bolt 54.

Accordingly, the disc brake device in accordance with the present invention includes an adjustable actuating lever for adjusting to different torques and suitable for attaching onto various kinds of bikes or cycles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A disc brake device for cycles comprising:
a brake disc,
a housing including a pair of brake shoes provided therein and disposed beside said brake disc,
an actuating member disposed in said housing for operating said brake shoes to act onto said brake disc, said actuating member including an extension extended therefrom,
a cam secured to said extension of said actuating member, and including a lever extended therefrom,
a brake cable including an inner wire, and
means for adjustably securing said inner wire to said lever.

2. The disc brake device according to claim 1, wherein said adjustably securing means includes a fastener for securing said inner wire to said lever at different locations, for allowing said inner wire to apply different torque against said cam with said lever.

3. The disc brake device according to claim 2, wherein said lever includes a plurality of recessed formed therein for selectively and adjustably receiving said inner wire.

4. The disc brake device according to claim 2, wherein said adjustably securing means further includes a washer engaged onto said fastener and engaged with said inner wire for securing said inner wire to said lever.

5. The disc brake device according to claim 4, wherein said washer includes a cavity formed therein for receiving said inner wire and for solidly securing said inner wire to said lever.

6. The disc brake device according to claim 2, wherein said lever includes a channel formed therein for slidably receiving said fastener, and a lock nut threaded with said fastener for securing said fastener and said inner wire to said lever.
